(19) United States
(12) Patent Application Publication
(10) Pub. No.: US 2018/0293356 A1
(43) Pub. Date: Oct. 11, 2018

(54) GENERATING, DELIVERING AND DISPLAYING CROSS PLATFORM PERSONALIZED DIGITAL SOFTWARE APPLICATIONS

(71) Applicant: Ramaswamy Narayana Melkote, Los Altos, CA (US)

(72) Inventor: Ramaswamy Narayana Melkote, Los Altos, CA (US)

(21) Appl. No.: 15/484,153

(22) Filed: Apr. 11, 2017

(51) Int. Cl. G06F 19/00; G06F 21/62

(52) U.S. Cl. CPC G06F 19/3418; G06F 19/322; G06F 21/62

(57) ABSTRACT

Personalized Application instructions such as heath care instructions are created, delivered and displayed. These instructions may be displayed on one or multiple devices. The devices are not specialized devices. They may be any one of the many devices readily available in the marketplace such as a smartphones, tablet computers, laptops or other computers. Better and effective communication between a caregiver and a patient improves patient care.

### FIELD

The present invention has many fields of application not limited to health care and electronic communications.

### BACKGROUND

This invention is applicable to any scenario where personalized instructions need to be delivered to a consumer via an electronic device and the consumer's response relayed back to a service provider. The invention is illustrated in detail in the field of healthcare where the consumer is a patient and the service provider is a doctor.

Most interactions between a doctor and a patient occur in the clinic or the hospital. Increasingly some communications now occur through electronic media such as computers, cell-phone etc. Increasing the interaction may increase the chances of accessing and receiving better health care.

There have been recent efforts to use the smart phones and other electronic media to influence health care outcomes. The use of these devices is limited in many ways. As an example, these known methods are used to send emails, make appointments, log into a web server to check on messages from health care providers or to check on test results. Known methods also exist to facilitate obtaining data related to the health condition of the user. Some of these known methods are limited in that a dedicated device is needed to enable the acquisition of data. As an example in U.S. Pat. No. 8,015,030, such a method is described which facilitates the transfer of data related to the health condition of the patient. This patent teaches the use of dedicated devices to monitor the user health.

Another example of a known method used to collect data from a patient can be found in US20110015496A1. In this publication essentially, a mobile communication device is attached to a sensor that is placed on the housing of the device. This sensor is used to collect data from the patient. There is no teaching related to personalized content generation or delivery.

### BRIEF DESCRIPTION OF THE DRAWING FIGURES

FIG. 1A is a diagram of a personalized instruction generation and delivery system.

FIG. 1B is a diagram of a personalized instruction generation and delivery system showing a connection to an external computer system from which information about the patient may be obtained.

FIG. 2 is an example of the different elements that may be utilized to create personalized instructions.

FIG. 3 is a more detailed diagram of the method of creating and delivering personalized instructions by using the system described in FIG. 1.

FIG. 4 is an example of what the Application Definition File may contain.

FIG. 5 is a table describing states that an Application on a patient device in the system of FIG. 1 goes through.

FIG. 6 is a diagram illustrating a rules based software architecture that may be used in the system of FIG. 1.

### DETAILED DESCRIPTION

Terminology:

Server Application: A software (SW) engine that resides in a server and manages various processes from for example, doctor/nurse entries to patient experience.

Device Dependent Core Application or Device Application: A SW application that resides on a patient's local device which accepts inputs from the Server Application and from the patient.

Application Definition file: A file that is created by the Server Application and transferred from the server to the patient's local device. Some contents within the Application Definition may be modified by the user.

Application: A general term that signifies software that the user interacts with and that is created by the caregiver.

Session: A period of interaction between the patient and the Device Application.

User Device: The device used by the end user, in this case the patient.

Most interactions between a caregiver such as a doctor and a patient occur in the clinic or the hospital. Often, these interactions occur in a very stressful environment. The instructions are easily forgotten or misunderstood. This leads to complications such as, for example, slow recovery or re-hospitalizations. This invention generally relates to providing methods and systems to assist caregivers in providing better healthcare.

In this invention, in general, the caregiver creates personalized instructions which are sent via a server to a User Device in possession by the patient, such as smartphone or tablet or a computer. The instructions are displayed on the User Device. The instructions may have, for example, a combination of text, photographs, animations, movie clips, drawings, voice, etc. The patient then interacts with this device and may respond to questions displayed, or announced on the device. A complete description of the interaction between the patient and the User Device is sent to the server. A status or a report is then made available to the caregiver, who may then choose to take further action, such as, for example, sending a new set of instructions.

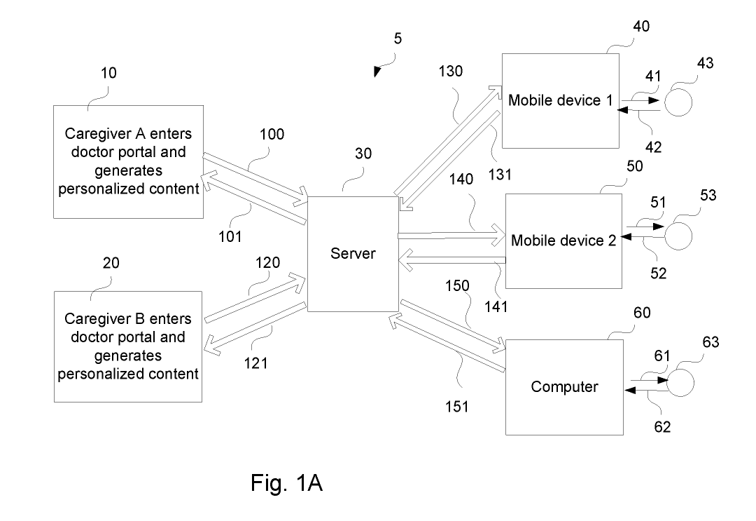

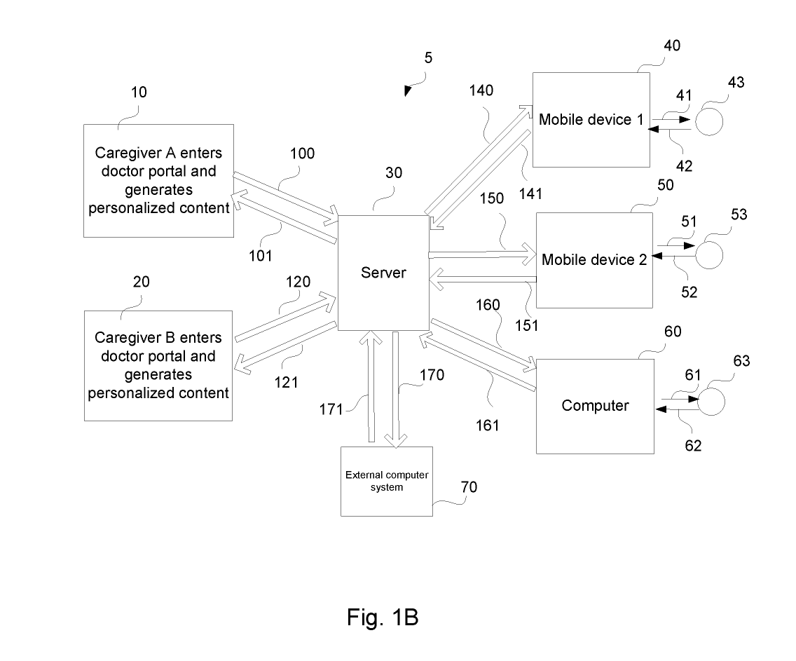

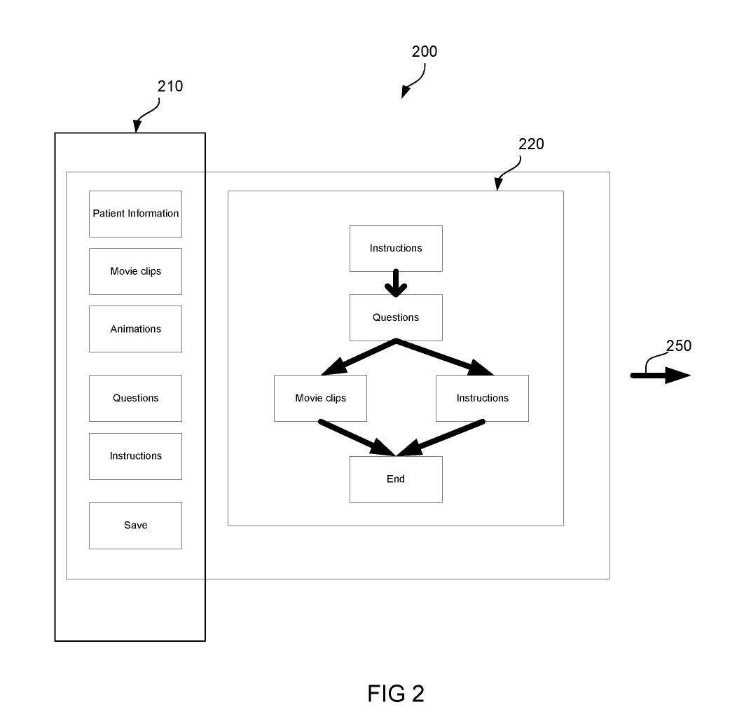

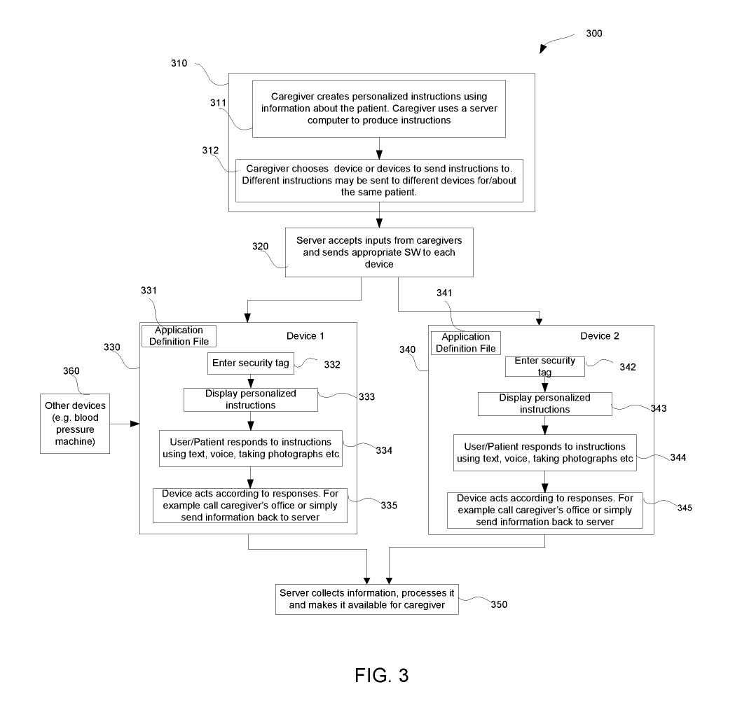

The invention will now be described with the help of FIG. 1A, 1B. FIG. 2 and FIG. 3. Referring now to FIG. 1A, a diagram is shown of a personalized instruction generation and delivery system. In a typical scenario, the patient receives instructions in one of many places such as for example, a doctor's office or a hospital or other care providing facility such as a medical clinic, an outpatient clinic a physical therapist clinic, a pharmacy or even a patient's home. In FIG. 1A, box 10 and 20 show the step of a caregiver creating an Application and more specifically creating the personalized instructions. This same step is shown in box 310 in FIG. 3. The process of creating these instructions is described in FIG. 2. Here the caregiver may use various types of media such as for example, movie clips, animations etc, shown in box 210 to create personalized instructions. Visualizing the system described in 200 as a computer screen, the caregiver would use for example, simple drag and drop operations from the box 210 into the area 220. In one embodiment the instructions are personalized according to information about the patient such as for example, demographics, disease state, language preference, gender, physical or mental abilities of the patient, etc. As an example of personalization, the caregiver may choose the language in which the instructions are displayed on the patient's device, while creating the instructions in English. As another example, the caregiver may personalize the instructions and questions displayed to the patient. As another example of personalization, the caregiver may choose to display text that appears on the patient's device with colors that can be read by a color blind person. In another example, the caregiver might deliver a completely different application flow based on feedback from patient

In one embodiment, the information about the patient may come, for example, from the patient himself or herself, or from an existing patient record or other means such as paper records or other electronic records. FIG. 1B shows the server 30 connected to another external computer 70. The computer 70 may provide information about the patient such as for example, electronic medical records.

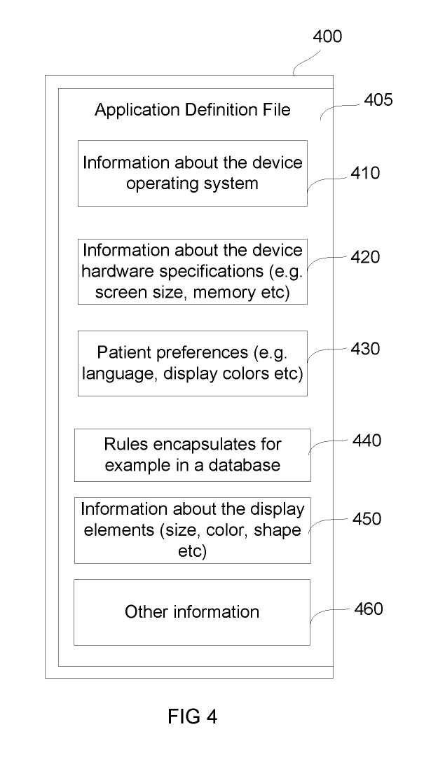

In one embodiment the patient's device has an Application Definition File. This is shown in FIG. 4. In this figure, box 400 is the patient's device such as 40, 50 or 60 in FIGS. 1A and 1B. The Application Definition File 405 is stored in the device 400. The function of the Application Definition File is to, for example, accept the instructions from the caregiver and control the display of these instructions on the patient's device as per information in this file such as for example, the capabilities of the patient's device, the language preference of the patient etc. The Application Definition File is created by sever 30 shown in FIG. 1. There are various methods by which the Application Definition File may come to exist on the patient's device. For example, it may be transferred at least once at the beginning of each session the patient initiates or may be downloaded into the patient's device by the patient himself or herself. This step generally has to be done only once for each device that will be used to display instructions. Yet another example of how the Application Definition File comes to exist on a User Device is as follows: a caregiver may change the definition subsequent to the initial deployment. If this situation occurs an SMS message or an alternative push notification is sent to the patient device triggering the device to load the new application definition file automatically.

In one embodiment, the Application Definition File allows the caregiver to create the personalized instructions without regard to the device the patient will use. The caregiver does not have to create a different Application for different devices such as iPhone™ or Android™ phones. The Application interprets the personalized instructions in the Application Definition File and displays information on the patient's device as per the capabilities and the type of device, the operating system and other characteristics which make each patient device unique.

Referring still to FIG. 1, once the instruction set (i.e. the set of instructions containing specific instructions, video, other information) is created, the caregiver deploys the instruction set. This is depicted by arrow 100 and 120 in FIG. 1A and FIG. 1B. A server 20 accepts the instructions, processes them and sends it to the patient's device as shown by arrows 130, 140 and 150. These steps are shown in greater detail in FIG. 3 in box 311, 312 and 320.

The role of server 30 of FIG. 1 is defined in some more detail in box 320 in FIG. 3. For example, the server 30 enables one or multiple caregivers to interact with one or multiple patients. As an example, the server may host a website or doctor portal, where the caregivers may have individual accounts. In one embodiment, the caregiver selects a patient record or creates a new patient record or accepts a patient record from another source as shown in FIG. 1B by arrows 171 and 70. The server 30 facilitates in this aspect. It also parses the instructions the caregivers send and sends the correct instructions to the correct patient device as shown in FIG. 1 by arrows 130, 140 and 150. The server 30 also plays a role in the presentation of patient information to the caregivers. This role will be discussed more below.

In FIG. 1, multiple patient devices 40, 50 and 60 are shown attached to patient 43, 53 and 63. The system 5 in FIG. 1 can, for example, accommodate the following situations: one caregiver sending instructions to one patient on one device, one caregiver sending instructions to one patient on multiple devices, one caregiver sending instructions to multiple patients on one or multiple devices, or multiple caregivers sending instructions to one or multiple patients with multiple devices. The server 30 may contain a database of caregivers and patients and software to accommodate all these and other situations not mentioned specifically above. It should be understood that while FIG. 1 shows multiple caregivers and multiple devices, the system 5 may be configured to accommodate any of situations described immediately above.

FIG. 3 describes an example of how the system 5 in FIG. 1 may be used. Here, the persons indicated by 43, 53 and 63 in FIG. 1 may not all be patients. One person, for example 43 may be a patient. Persons 53 and 63 may be members of the patient's family. The caregiver in step 310 in FIG. 3 may want to send instructions or information to the patient's family members. The caregiver may choose to send different information and instructions to different members of the patient's family according to their role in the care of the patient. For example person 53 may be the patient's mother and may be the person providing food for the patient. The instructions may state that low sodium food must be prepared. In this example, information about the patient may come from many sources including for example persons 53 and 63. The server 30 in FIG. 1 collects all this information from various inputs and makes it available to the caregiver.

The patient devices such as 40, 50 and 60 may also accept responses from the patient. In one embodiment, the input may be, for example, text, numbers, alphanumeric, voice, etc., or output from another device such as a blood pressure machine such as shown in box 360 in FIG. 3.

In one embodiment, the devices such as 40, 50 and 60, may accept the response and analyze the input. For example, if after heart surgery a patient's weight seems to be increasing, the device may tell the patient to call the doctor immediately or may call the doctor automatically. This is shown in box 335 and 345 in FIG. 3.

The server 30 updates its database as instructions from caregivers or responses are received. When the caregiver wants a summary or status of the patients, the same portal may be used as when the personalized instructions were created. The server 30 may have Server Application software that may accomplish several tasks; for example, it may order presentation of a summary to a caregiver according to the responses or non-responses from the patient.

Software Engine

The software engine will now be described in greater detail. This software engine may be a simple rule based engine. There are many ways a rules driven engine may be implemented. The rules are defined in the Application Definition file as shown in box 405 in FIG. 4. As discussed earlier, the Application Definition File is created by the Server Application which resides in the server 30. The rules are generated by the Server Application according to the inputs provided by the caregiver. Some aspects of the rules may be modified by the user such as placement of instructions on the screen, language etc. The Application Definition File is a mechanism by which user preferences are saved and accessible on various devices such as 40, 50 or 60. It should be noted that the Application Definition File may generally be different for each device. For some examples, the Application Definition File may be similar, depending on the make and model of the device.

In one embodiment, the rules in the Application Definition file determine the user experience and may be the primary mechanism which determines the behavior of the Device Application including, for example: questions to be displayed to the user and/or text that is to be converted to speech; media containing information that is to be displayed to the patient such as instructions for examining a wound, dressing the wound, or other information; inputs that are expected from the user either in the form of button clicks, speech input, etc.; confirmation to the patient concerning the input received so far; actions that will be taken by the application based on input from the patient, etc. This is shown generally in box 440 in FIG. 4.

The Application Definition file may also utilize the resources of the local device 40, 50 or 60. These include, for example, alarms and calendar and other utilities found on the device.

In one embodiment, the Device Application on the patient's device such as 40, 50 or 60 parses the Application Definition File and may create a database. The Application Definition File populates this database. The database stores information such as transcripts of user session, user responses, etc. As explained above, the Application Definition File indicates such information as the times of the day that the Device Application needs to interact with the patient. The patient has the option of modifying some behaviors such as choosing a more convenient time to interact with the Device Application.

In one embodiment a database is not created on the patient's device such as 40, 50 or 60. The responses are sent back directly to the server 30.

The Device Application alerts the patient at a pre-determined time. The alert mechanism follows the usual alarm mechanisms of snooze, stop, etc. Appropriate actions are taken once the user responds to the alarm. Additionally, the Device Application will alert the caregiver's office if the patient does not respond. In one embodiment, when a patient enters data, data triaging occurs. If the patient enters data that requires immediate attention then the User Device will call/notify the doctor's office immediately.

When a patient such as 43, 53 or 63 interacts with system 5 of FIG. 1, a Session is commenced on at least one of devices such as 40, 50 or 60. The Session behavior may be controlled by the Application Definition File. A Session may comprise of one or multiple states. A “state” is simply the status of the Session at any time. A “state” may also represent a set of programming steps or logic to achieve a specific task. A Session may be in one or several states at any one time. A state may be used to classify an object such as a patient or a set of tasks (for example user interface tasks). For example, a state may present a question to the patient, or may present some information to the patient, or may ask for a response from the patient.

Application Definition File

The content of the Application Definition File is now described. As shown in FIG. 3, The Application Definition File such as 331 or 341 resides in the User Device 330 or 340. It should be noted again that while FIG. 3 shows two User Devices, there may be one or more than one Device. Now referring to FIG. 4, in one embodiment, the Application Definition File may contain: a list of possible states of the interaction (i.e. current state within a session); the interactions to be performed based on the current state; question for the patient; information for the patient; buttons corresponding to expected inputs which the patient may use to confirm/deny the symptom posed by the question; action to be taken on certain responses by the user or no response by the user, etc. It also may include, as shown in FIG. 4, for example, information about the device operating system, information about the hardware specifications (screen size, memory etc), patient preference (language, colors etc). Another key component of the Application definition File is the rules which define the Device Application flow. This is shown in box 440 in FIG. 4. In general, the Application Definition File controls the application behavior.

In one embodiment as shown in box 450 in FIG. 4, the display of the instructions contains one or multiple display elements. A display element may be, for example, text, movie, clips, animations, pictures etc. The Application Definition File may store information about, for example, size, shape, color, position on the screen, orientation within the screen to be used for each display element.

In one embodiment, depending on the state of the Device Application, such as the nature of the question, a non-response can be configured to mean either that the patient responded in the negative, or if there was a specific button to indicate a negative response, it can be construed as a timeout, and the appropriate actions can be taken—such as sounding an alarm, or sending a message to the caregiver, or skipping that question.

When a patient is interacting within a session, at the end of each state, if needed, a confirmation is provided. At the end of the session, a summary is presented to the patient along with any follow up actions such as automatic notification of the doctor's office for follow-up. Additionally, the patient is provided with important tips, as well as a reminder of upcoming appointments. A log of the interaction is sent to the server 30. The caregiver can then access this log.

In one embodiment, the Device Application can be implemented on multiple devices. The user can use multiple devices to interact with the server. This way the user has complete flexibility on which device he or she chooses to use. As an example, the user may choose to use an iPhone one day and may choose a laptop another day. The responses and Application flow are consistent across the various devices.

In one embodiment the user can interact with multiple devices even within a Session.

Patient/Device Interaction

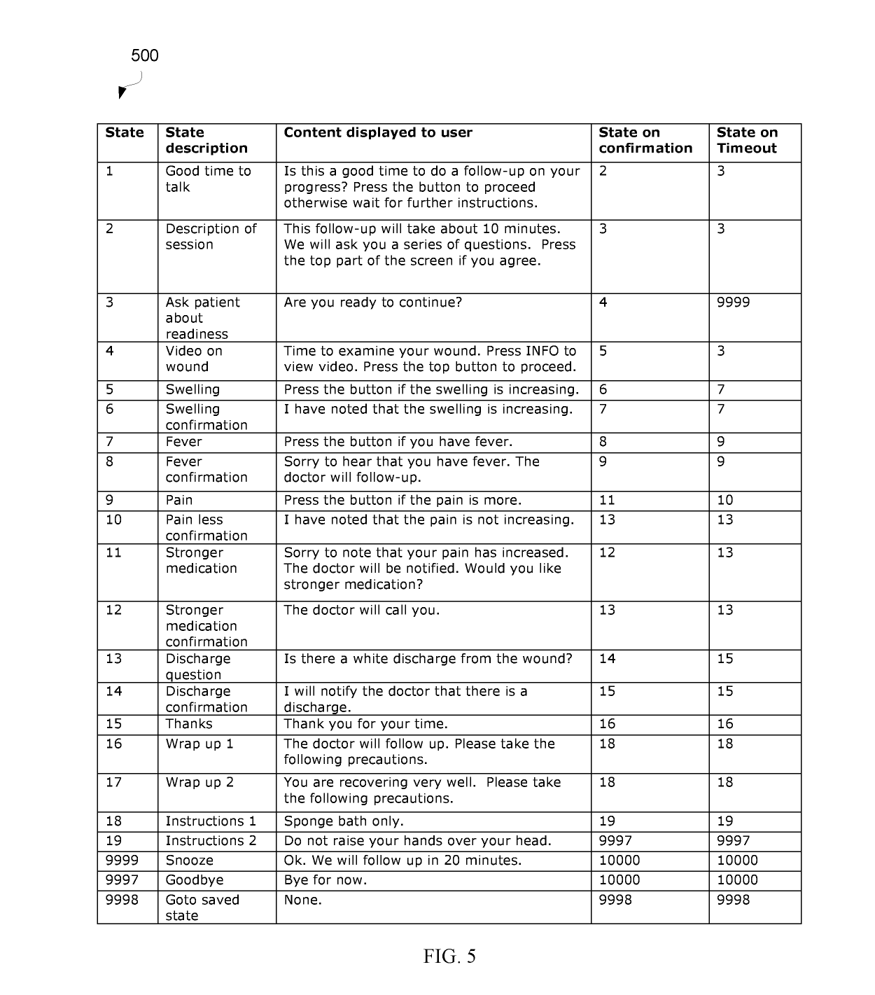

The interaction between the patient and the patient device such 40, 50 or 60 is now described. As noted above, this interaction is dictated by the rules within the Application Definition File. FIG. 5, shows an example a section of rules within an Application Definition File. The patient starts the Device Application, for example, manually, or based on an alarm. The Device Application may also start automatically. The start behavior is defined in the Application Definition file. The patient sees the text in the column named “Content displayed to user”. The Device Application goes through a number of states starting with state 1. If the patient answers in the affirmative, then the Device Application will go to the state specified in the column “State on confirmation”. If the patient does not provide an input, the Device Application will go to state defined in the “State on Timeout” column. Thus the entire behavior of the Device Application is defined in the rules. A UI state can lead to one of multiple next UI states based on user input. Also a UI state can use available UI layouts like but not limited to: Date/time Picker, custom pickers, tables, list of values, toggle buttons, buttons, labels, images etc.

In one embodiment, data can be entered into the patient's device such as 40, 50 or 60 in multiple ways. For example, the data can be typed in by the patient or the data can be entered via sensors as shown in box 360 in FIG. 3. The sensors may collect data continuously or when commanded by the Device Application or both. The sensors may communicate with the User Device wirelessly or through wired means.

Software Architecture

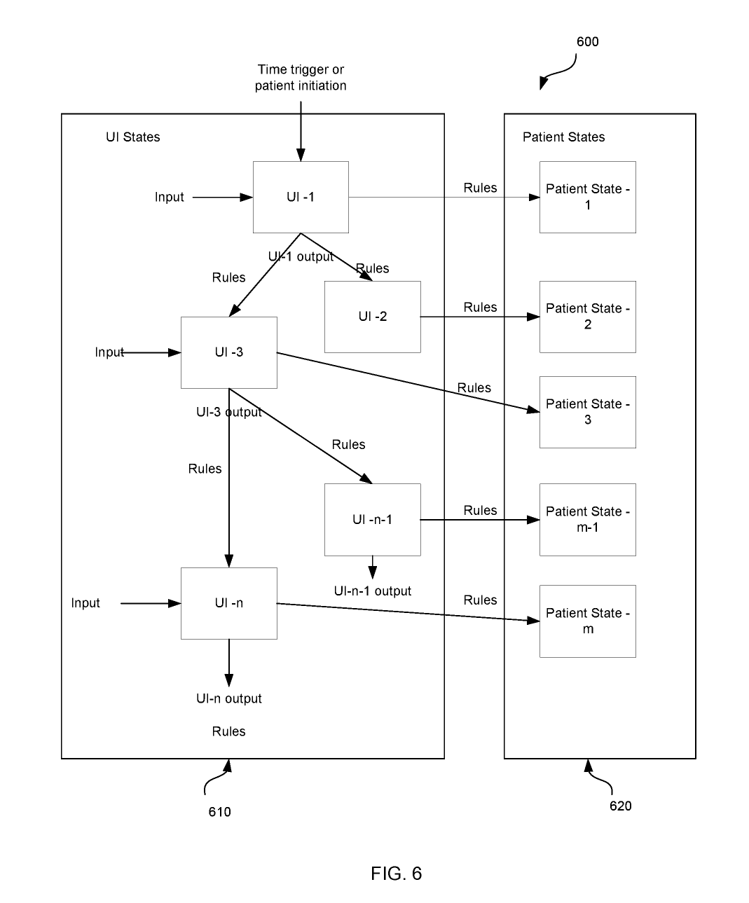

The Application Definition file is part of a software architecture, which will now be described in relation to FIG. 6. The goal of this software architecture is to create a software package that can be deployed in various hardware platforms without having to re-write the software for each hardware platform. The software architecture can be described by a state machine 600 in FIG. 6. This figure shows two state machines as an example. The architecture may have one or many state machines. A “state” as defined earlier, is simple the status of the Session at any time. Also as stated earlier, there may be one or multiple states. Specifically, in the context of this software architecture, it is convenient to think of a User Interface (UI) state and a model state or patient state. A UI state may describe “what” information is to be displayed and “how” (layout and appearance of the information) it should be displayed. Referring to FIG. 6, a state can either be a UI state as discussed above and shown within the box 610 or a patient state shown in box 620. A patient state may be thought of as a classification of a patient. For example, a patient may be classified as red, yellow, or green. A red classification may mean that the patient needs immediate attention. A yellow classification may mean that the patient may need attention soon. A green classification may mean that the patient is just fine and needs minimal attention. Other classifications are possible. Multiple classifications are also possible. Referring still to FIG. 6, an example is now described in relation to the table found in FIG. 5. When the patient's device starts executing the Device Application, it enters the state labeled UI-1 in box 610. This may relate to state 1 in FIG. 5. The text “Is this a good time to do a follow-up on your progress? Press the button to proceed otherwise wait for further instructions.” may be displayed on the patient's device. If the patient answers affirmatively, FIG. 5 shows that the next state will be state 2. If the patient does not answer, state 3 is attained. Referring again to FIG. 6, the patient input or lack of input determines if the next UI state will be UI-2 or UI-3 in box 610. The rules determine the next UI state. This mechanism can be used to determine, for example, the next question or piece of information to provide to the patient.

FIG. 6 shows the patient state (which FIG. 5 does not). If the patient answers affirmatively for the question posed in UI-1 in box 610, the underlying rule for this specific UI state (UI-1) may classify this patient green at this stage of the application. So the value of “Patient State-1” in box 620 may be green. If the patient had not responded, the same rule for this UI state (UI-1) may have classified this patient red.

There does not need to be one to one correspondence between a patient state and a UI state. A UI state does not have to change a patient state.

A rule associated with a UI state may change the classification of a patient attained by a previous UI state.

A rule may not always be associated with a specific UI state. As an example, a rule at the end of a session may analyze all the responses and make a final determination of the patient state.

Box 610 in FIG. 6 also shows inputs to the UI states. These inputs may be, for example, an input entered by the patient, an output of another machine such as a blood pressure machine, text, voice, photographs taken by the patient, etc.

It will be appreciated by those of ordinary skill in the art that the present invention may be embodied in other specific forms without departing from the spirit or essential character thereof. The disclosed embodiments are therefore intended in all respects to be illustrative and not restrictive. The scope of the invention is indicated by the appended claims rather than the foregoing description, and all changes which come within the meaning and range of equivalents thereof are intended to be embraced therein.

What is claimed is:

1. A method of providing software application instructions comprising the steps of:
creating personalized content in an electronic form for at least one patient/consumer;
delivering the electronic content to at least one first electronic device;
displaying the electronic content on the at least one first electronic device;
having the patient/consumer provide input about his or her condition by using the first electronic device in response to the personalized content;
having the first electronic device send the responses back to at least one second electronic device;
having the second electronic device provide a status of the at least one patient/consumer.

2. The method of claim 1 where the creation of personalized content step further comprising a selection step comprising at least one of:
selecting an existing patient/consumer record;
creating a new patient/consumer record;
accepting a patient/consumer record from another source.

3. The method of claim 1 wherein the electronic content is at least one of text, graphics, photographs, electronic files, animations, clips, references to other electronic or non-electronic material.

4. The method of claim 1 wherein the electronic content is personalized according to information about the patient/consumer.

5. The method of claim 4 wherein the information about the patient/consumer could be one of but not limited to age, height, weight, language, demographic, race, culture, physical ability, mental ability, general heath, health history.

6. The method of claim 1 wherein the first electronic device receiving said personalized content is at least one of a smart phone, a computer, a laptop or a tablet device.

7. The method of claim 1 further comprising a security step wherein the first electronic device does not display the electronic content until a security tag is entered.

8. The method of claim 7 wherein the security tag is at least one of a password, a security question, a biometric reading or other electronic entry.

9. The method of claim 1 wherein the delivering step comprises delivering the electronic content to the patient/consumer and at least one of a caregiver, friend, family members, other authorized personnel.

10. The method of claim 9 wherein the content is personalized according to each person's role.

11. The method of claim 1 wherein input providing step is accomplished by using at least one of gesturing on the device, typing in text, typing in numbers, using voice or automatically by accepting the output of another machine

12. A method of addressing a condition of a person comprising:
a user using a server-based computer tool for producing instructions;
a server creating a one or more definitions and one or more applications for use by the person, the one or more applications being structured to carry out the interaction in accordance with the definition;
the person using one or more devices for running the one or more applications;
in the course of running the one or more applications, soliciting feedback from the person concerning the condition;
communicating the feedback from the one or more devices to one or more servers, and tracking the feedback; and
at least one of: communicating the feedback to the user; and making the feedback accessible to the user.

13. The method of claim 12 wherein the device used by the person is at least one of a smart phone, a computer, a laptop or a tablet device.

14. The method of claim 12 wherein the server is at least one of a computer or a laptop.

15. The method of claim 12 wherein the definition resides within the device.

16. The method of claim 15 wherein the definition further comprises at least one of information about the device, information about the application, or information about the person.

17. The method of claim 16 wherein the information about the application further comprises information about how to display the instructions on the device.

18. The method of claim 17 wherein the information about how to display the instructions further comprises at least one of size, shape, color, position on the screen, orientation within the screen to be used for each display element.

19. The method of claim 12 where the device evaluates the feedback and takes action based on the feedback.

20. The method of claim 19 wherein the action further comprises at least one of displaying a message, sounding an alarm, calling a health care provider, calling a service provider, passing the message on to the server.

21. The method of claim 12 where the definition is a database.

22. The method of claim 12 further comprising a modification step wherein the instructions are modified based on the feedback.

23. A method of creating personalized application instructions comprising:
choosing to display of at least one of a message, instructions, questions or information;
choosing a next action based on a response;
determining a classification of an object based on at least one response; and
creating a software file containing this information for the first electronic device.

24. The method of claim 23 wherein the response is at least one of a response or a no response.

25. The method of claim 23 wherein an object is at least one of a patient, or a user.

26. A personalized application instructions generation and communication system comprising at least:
a first electronic device;
a second electronic device; and
a third electronic device;
wherein the first electronic device is configured to display application instructions;
wherein the second electronic device is configured to communicate between the first electronic device and the third electronic device; and
wherein the third electronic device is configured to generate application instructions.

27. The system of claim 26 wherein the first and third electronic device is at least one of a smart phone, a computer, a laptop or a tablet device.

28. The system of claim 26 where the second electronic device is at least one of a computer or a server.
